(19) United States
(12) Patent Application Publication
(10) Pub. No.: US 2007/0160245 A1
(43) Pub. Date: Jul. 12, 2007

(54) Personal voice-transmitted device

(76) Inventor: Yan-Ru Peng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/605,418

(22) Filed: Nov. 29, 2006

(30) Foreign Application Priority Data
Jan. 10, 2006 (TW) 95100896

(51) Int. Cl. H04R 1/02

(52) U.S. Cl. 381/334; 381/335

(57) ABSTRACT

A personal voice-transmitted device includes at least one voice box and at least one voice-transmitted tube. The voice box has a speaker arranged therein, and is divided to a first space and a second space by the speaker. The voice-transmitted tube connects to one side of the voice box and extends outwardly and has an outlet. The device can generate and retain a low-pitched tone by resonance of the first space, and the low-pitched tone can be transmitted to the outside by the voice-transmitted tube to form an excellent low-pitched tone. The drawbacks of the prior art such as poor tone because of using an earphone, a shutting stress and an uncomfortable feeling because of inserting an earphone, an unsafe feeling because of hanging an earphone and a sanitation problem because of contacting an earphone can be improved. The device can be used with no restriction on occasions and time.

### BACKGROUND OF THE INVENTION

1. Field of the Invention

The present invention relates to a personal voice-transmitted device and, more particularly, to a personal voice-transmitted device, which allows a speaker to emit voice toward both ears of a user through the resonance of a front cavity and the transmission of a voice-transmitted tube, thereby improving the music transmission effect of existent earphones.

2. Description of Related Art

FIG. 1 shows a prior art MP3 player 10a, which can store MP3 music files. The MP3 player 10a has to connect an earphone 11a. The earphone 11a is electrically connected to the MP3 player 10a via a transmission wire 12a. The user needs to place the earphone 11a into his ears to listen to MP3 music. The types of the earphone 11a include circumaural type, ear hook type, insert type and earplug type. The earphone 11a directly contacts the ears of the user, and will press the ears of the user after longtime use to cause discomfort, hence not meeting the requirement of comfort pursued by people. Moreover, because the earphone 11a directly contacts the ears, dirt and grease will accumulate on the earphone 11a to cause a sanction problem. Secondly, a shutting stress to the ears will easily cause a uncomfortable feeling and isolate the outside voice. The user will hardly be conscious of the outside situation, and will act and react hesitantly, hence having a problem in safety. Furthermore, the tone of the earphone 11a depends on a speaker (not shown) in the earphone 11a and the MP3 player 10a itself. Prior art earphones produce a near-ear tone by plugging the speaker into the ears or pressing the speaker close to the ears. The near-ear tone makes no use of space resonance for generating a resonance tone. Therefore, the produced tone is of low quality, and cannot be provided for the user to enjoy the sound field. Besides, the situation and time of use of the earphone 11a is also much restricted. For instance, when running, the earphone 11a worn on the user will easily slide. When riding a bicycle, wearing the earphone 11a will cause hesitant actions and reactions of the user, hence having a problem in safety.

FIGS. 2A to 2C show the earphone clip structure of a prior art earphone. The earphone clip structure makes use of an earrings elastic plate to firmly clip on the ear. As shown in FIGS. 2A to 2C, the earphone 1b clip structure comprises an assembly base 2b and a clip member 3b. In the assembly base 2b, groove embankments 21b at both sides form an insertion groove 22b, and embedding embankments 23b at the rear portion form an embedding groove 24b. The clip member 3b has an embedding plate 31b and a clip plate 33b. A pivotal base 32b is disposed at the bottom end of the embedding plate 31b. An elastic plate 34b extends from the center of the clip plate 33b. An extension plate 35b extends from two sides of the elastic plate 34b. An axial end 36b that protrudes outwardly is disposed at the bottom end of the extension plate 35b. The axial end 36b at two sides of the extension plate 35b can be assembled with the pivotal base 32b at the bottom of the embedding plate 31b.

In the above manner, the insertion groove 22b of the assembly base 2b can be provided for the insertion assembly of an earphone 1b, and the embedding groove 24b of the assembly base 2b can be provided for the embedding assembly from down to up of the embedding plate 31b. The user can makes use of the always-open state of the clip plate 33b and the embedding plate 31b to clip at the earlobe. When the earphone 1b located in the assembly base 2b is plugged into the ear, the clip plate 33b is pulled back to clip the clip plate 33b at the earlobe. Because the clip plate 33b is located on the assembly base 2b, the earphone 1b that is plugged into the ear thus has a positioning and fixing effect.

However, for the earphone clip of the prior art earphone, it is necessary to embed the earphone 1b in the embedding groove 24b of the assembly base 2b and then firmly clip the clip plate 33b at the earlobe through collocation of the embedding plate 31b and the clip plate 33b of the clip member 3b so that the earphone 1b can contact the ear canal of the user. Therefore, in addition to the complexity and difficulty of the structure and assembly of the prior art earphone clip, the earphone 1b has to contact the ear canal of the user, hence causing problems in sanction and comfort of use when the user enjoys music by using this earphone clip structure for a long time.

Moreover, the earphone utilizing the prior art earphone clip also belongs to near-ear earphones. The produced tone is of low quality. Moreover, the produced low-pitched tone easily scatters and cannot be effectively concentrated. Because the earphone clip is primarily designed to clip and fix at the earlobe of the user, this kind of earphone is usually used as a voice earphone instead a stereo sound effect earphone.

As shown in FIGS. 3A and 3B, a prior art earrings type earphone 1c comprises an upper cover 10c, a bottom cover 20c, and a speaker 30c arranged in the inner space between the upper cover 10c and the bottom cover 20c. The speaker 30c is connected to a reception wire 31c, which goes out via a through hole 11c of the upper cover 10c. The surface of the upper cover 10c has a plurality of small holes 12c. An ear clip 40c is disposed on the back of the bottom cover 20c.

The earphone 1c is fastened to the ear of the user through the ear clip 40c and the collocation of the upper cover 10c and the bottom cover 20c. The earphone 1c is used like an earrings worn at the earlobe so that the user can still communicate with others when listening to music.

The above earrings type earphone is primarily clipped at the earlobe of the user as an earrings. It also belongs to near-ear earphones. The produced tone is also of low quality.

In summary, for the prior art earphones, the earphone body is directly plugged into the ear of the user. Because the earphone directly contacts the ear, stress to the ear will cause discomfort after longtime use, and the user has to temporarily take off the earphone, hence being not able to continue enjoying the music. Moreover, because the earphone is plugged into the ear to directly contact the ear, dirt and grease in the ear will accumulate on the earphone after longtime use to cause a problem in sanction. According to a U.S. report, plugging an earphone into the ear for a long time will not only cause discomfort and sharp pain of the user, the bacteria on the earphone will also cause inflammation of the ear, hence having much doubt in sanction. Moreover, if the user uses the earphone improperly, the earphone will harm his body or even endanger his life.

In consideration of the sense of hearing of children, their eardrums and inner ears are more fragile than those of adults, and they are more sensible to voice but have a relatively weaker discrimination capability of voice. If they wear a stereo earphone, because the stereo earphone will shut the external ear canal and directly transmit the generated voice to the eardrum, the sound pressure will directly stimulate the sense of hearing. Wearing the stereo earphone for a long time will lead degradation of the hearing and much weakness of the sensitivity of hearing.

The prior art earphone is plugged into the ear to achieve a shutting feeling so as to isolate external sound. This shutting feeling will easily make the user hard to be conscious of the external situation. The user will thus act or react hesitantly to cause much doubt in safety.

Even if the prior art earphone is clipped at the earlobe of the user via an earphone clip instead of being plugged into the ear, the earphone is designed to be a near-ear earphone. Its tone is of low quality, and the low-pitched tone easily scatters and cannot be effectively concentrated. Therefore, a stereo effect of music cannot be effectively accomplished. Moreover, the tone of music cannot be enhanced through a special design of the earphone.

Accordingly, the present invention aims to propose a personal voice-transmitted device to solve the above problems in the prior art.

### SUMMARY OF THE INVENTION

An object of the present invention is to provide a personal voice-transmitted device to improve the insufficiency of low-pitched tone of the prior art earphones and concentrate the voice and guide its direction so as to avoid scattering of voice and bad sound effect.

Another object of the present invention is to provide a personal voice-transmitted device to concentrate the voice and emit the voice toward the ears of the user so that the user can fully enjoy the sound effect. Moreover, the device won't produce much influence to the nearby environment and won't unduly affect others. Through the special design of the present invention, the user needs not to let the earphone directly contact with his ears. Therefore, the drawbacks in the prior art such as poor tone because of using an earphone, a shutting stress and an uncomfortable feeling because of inserting an earphone, an unsafe feeling because of hanging an earphone, a sanitation problem because of contacting an earphone and a safety problem of isolating sound of the outside world can be solved.

Yet another object of the present invention is to provide a personal voice-transmitted device, in which a voice-transmitted tube extends from a main body, and a first space in the main body and a speaker together generates and retains a resonance tone by a resonance of the first space. The resonance tone is transmitted to the ears of the user via the voice-transmitted tube. Through the special design of the present invention, the user can retain the low-pitched tone without the need of a resonance of the ear cavity. It is not necessary to plug the voice-transmitted device into the ears to enjoy an excellent resonance tone. Moreover, the usage won't cause any shutting feeling to result in hesitant actions and reactions and damage of the hearing.

To achieve the above objects, the present invention provides a personal voice-transmitted device, which comprises a speaker and a voice-transmitted tube. The speaker has a first space and a second space. The voice-transmitted tube is joined with the speaker. The voice-transmitted tube has an outlet.

To achieve the above objects, the present invention also provides a personal voice-transmitted device, which comprises at least one voice box and at least one voice-transmitted tube. A speaker is arranged in the voice box. The voice box is divided to a first space and a second space by the speaker. The voice-transmitted tube connects to one side of the voice box and extends outwardly. The voice-transmitted tube has an outlet.

To achieve the above objects, the present invention also provides a personal voice-transmitted device, which comprises a main body, a speaker and a locking structure. The main body includes a first shell and a second shell collocated with the first shell. The first shell has a first space and a voice-transmitted tube extending outwardly from the first shell. The voice-transmitted tube has an outlet connected with the first space. The second shell has a second space. The speaker is arranged between the first shell and the second shell and near the first space. The locking structure is disposed on the outer side of the first shell so that the voice-transmitted tube can be arranged on an ear of a user. Thereby, the speaker forms a resonance tone in the first space, and the resonance tone is transmitted to the outlet of the voice-transmitted tube via the voice-transmitted tube. The low-pitched tone can be retained without the need of a resonance of the ear cavity.

### BRIEF DESCRIPTION OF THE DRAWINGS

The various objects and advantages of the present invention will be more readily understood from the following detailed description when read in conjunction with the appended drawing, in which:

FIG. 1 is a diagram showing the use state of a prior art MP3 player;

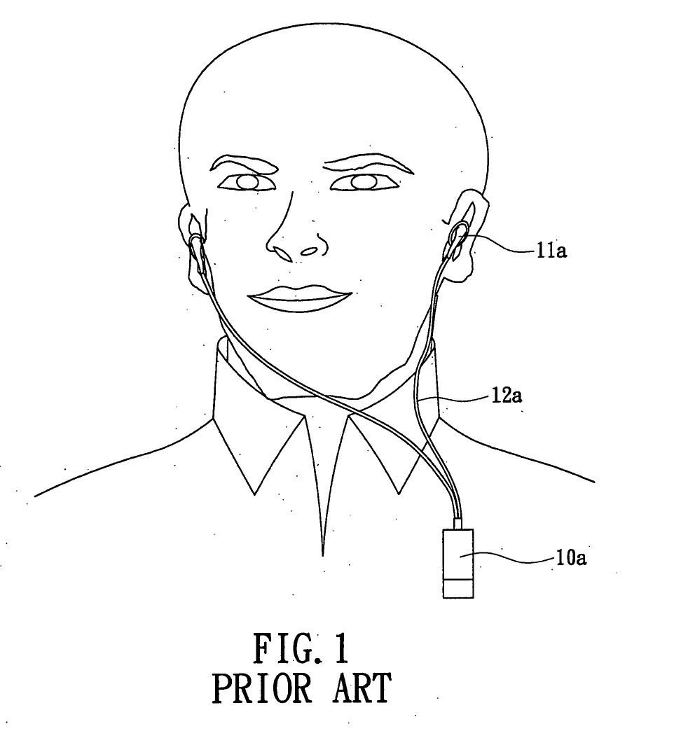

FIG. 2A is an assembly diagram of the earphone clip structure of a prior art earphone;

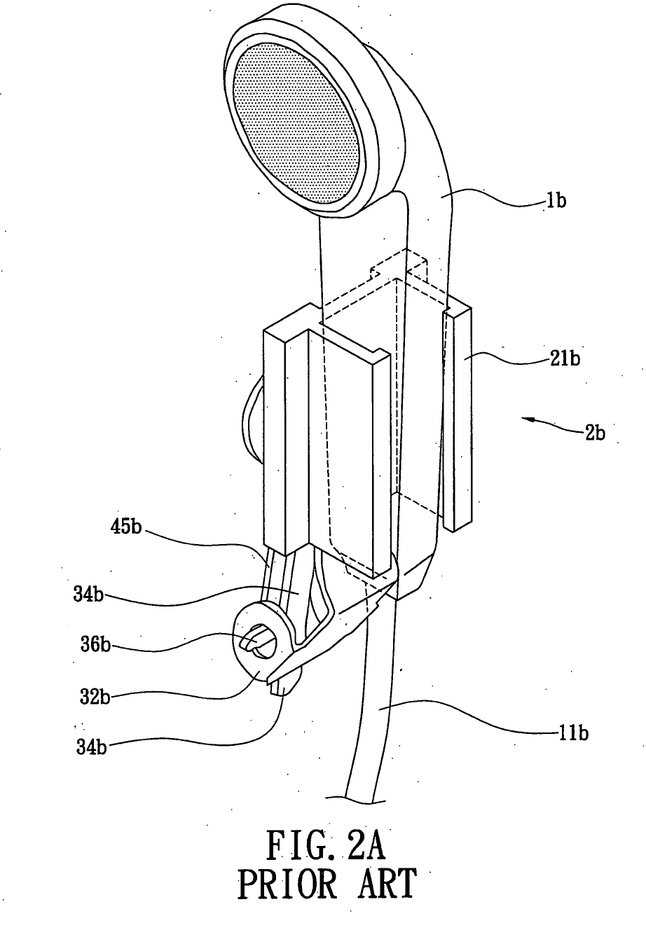

FIG. 2B is an action diagram of the earphone clip structure of a prior art earphone;

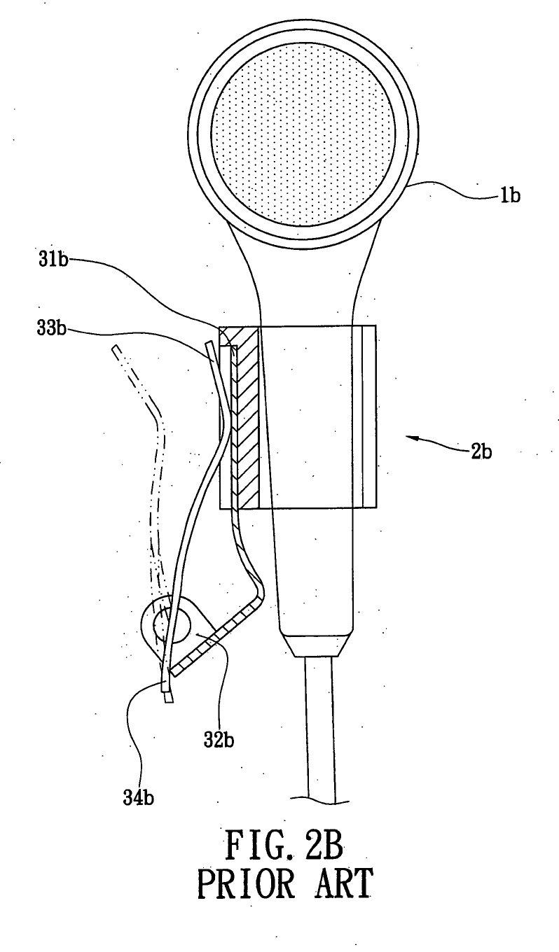

FIG. 2C is a diagram showing the use state of the earphone clip of a prior art earphone;

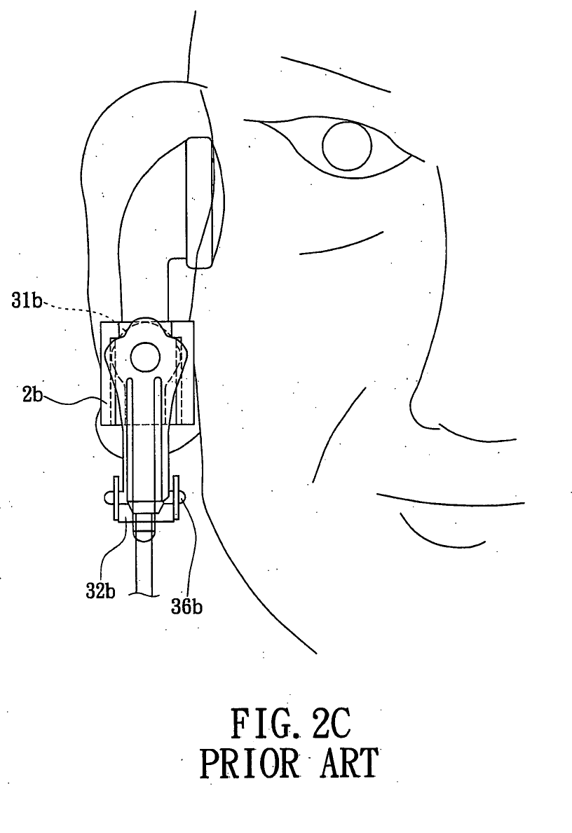

FIG. 3A is an exploded view of a prior art earrings type earphone;

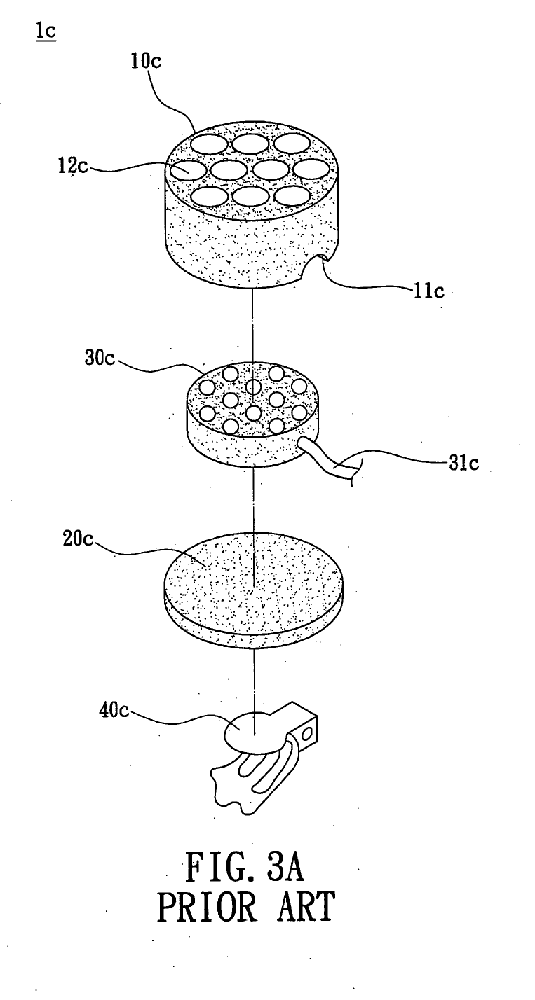

FIG. 3B is a diagram showing the use state of a prior art earrings type earphone;

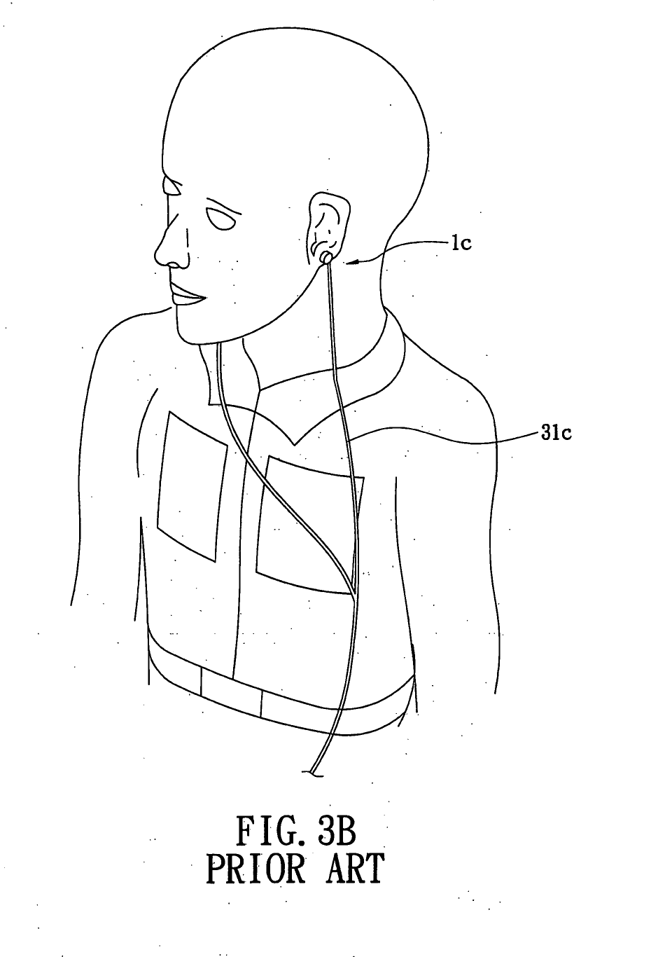

FIG. 4 is a perspective view of the personal voice-transmitted device according to a first embodiment of the present invention;

FIG. 5 is a plan view of the personal voice-transmitted device according to the first embodiment of the present invention;

FIG. 6 is an exploded view of the personal voice-transmitted device according to the first embodiment of the present invention;

FIG. 7 is an exploded view showing the use state of the personal voice-transmitted device according to the first embodiment of the present invention;

FIG. 8 is an exploded view of the personal voice-transmitted device according to a second embodiment of the present invention;

FIG. 9 is a plan view of the personal voice-transmitted device according to the second embodiment of the present invention;

FIG. 10 is a perspective view of the personal voice-transmitted device according to the second embodiment of the present invention;

FIG. 11 is a diagram showing a first use state of the personal voice-transmitted device according to a third embodiment of the present invention;

FIG. 12 is a diagram showing a second use state of the personal voice-transmitted device according to the third embodiment of the present invention;

FIG. 13 is a diagram showing a third use state of the personal voice-transmitted device according to the third embodiment of the present invention; and

FIG. 14 is a diagram showing a fourth use state of the personal voice-transmitted device according to the third embodiment of the present invention.

### DETAILED DESCRIPTION OF THE PREFERRED EMBODIMENTS

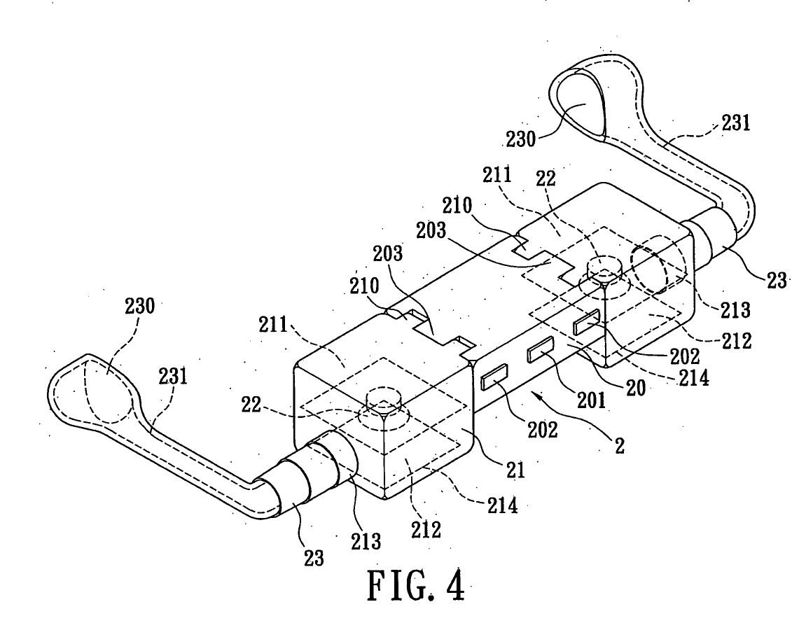

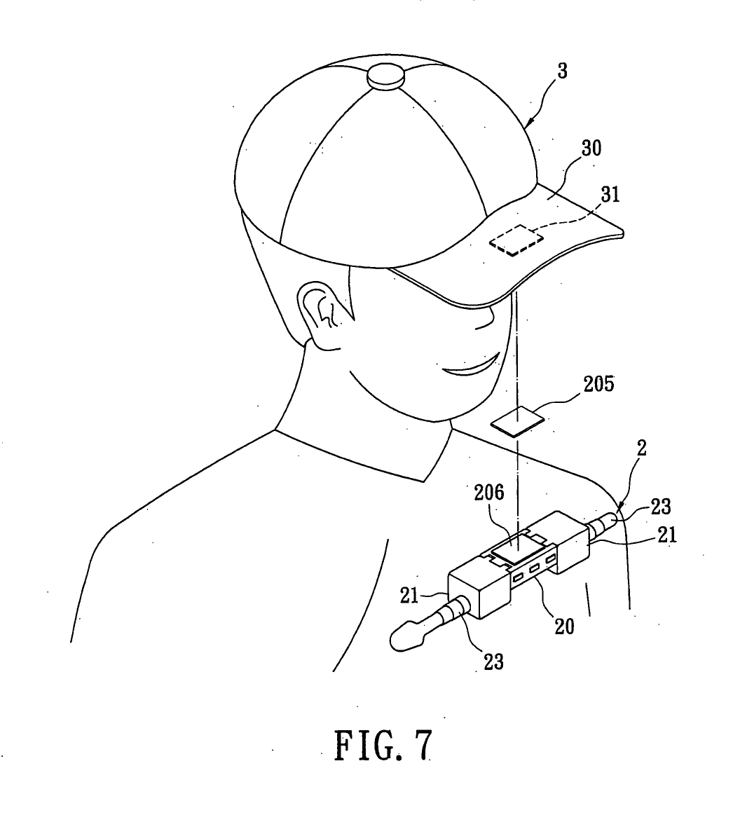

As shown in FIGS. 4 and 7, the present invention provides a personal voice-transmitted device 2, which comprises a multimedia player 20, at least one voice box 21 and at least one voice-transmitted tube 23. In this embodiment, the multimedia player 20 is flat, and can play MP3 music and listen to AM (Amplitude Modulation) and FM (Frequency Modulation) radio. However, the appearance of the multimedia player 20 is not limited in the present invention. The multimedia player 20 can of designed to be of any shape such as circular arc-shaped, rectangular shape, and so on. A control switch 201 is disposed on the multimedia player 20 to control the on/off state of the multimedia player 20. Moreover, another control switch 201 (not shown) can be disposed on the voice-transmitted tube 23 to control the voice-transmitted system (e.g., a speaker 22 electrically connected to this control switch 201) in the voice-transmitted tube 23. The voice box 21 can be square or circular arc-shaped.

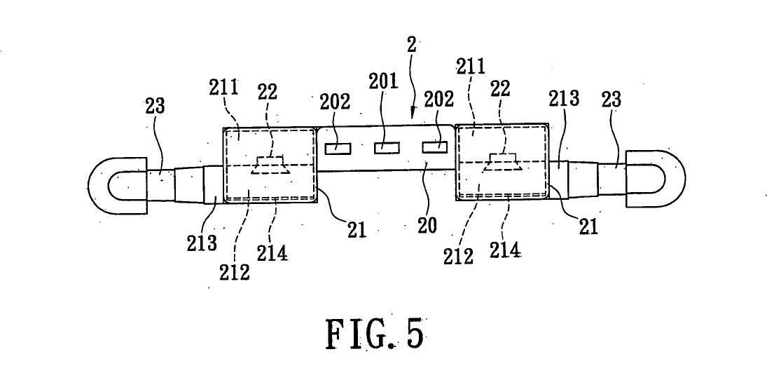

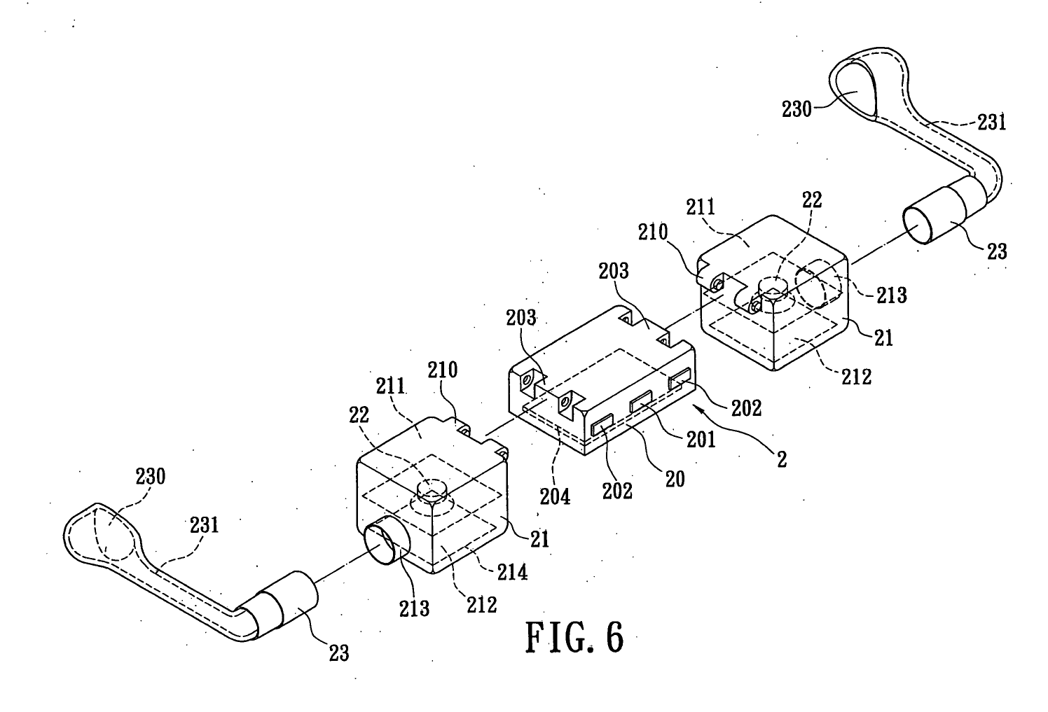

FIGS. 4 to 6 show a first embodiment of the present invention. As shown in FIGS. 4 to 6, two voice boxes 21 connect to two sides of the multimedia player 20, respectively. Each voice box 21 is movably and pivotally joined with the multimedia player 20. Two extension portions 210 extend from one side of each voice box 21. Each pivotal portion 203 forms at two sides of the multimedia player 20 respectively. The extension portions 210 are pivotally joined with the pivotal portions 203 respectively. Each voice box 21 is hollow. A speaker 22 can be arranged in each voice box 21 to provide high-pitched tone, middle-pitched tone and low-pitched tone. Each voice box 21 is divided to a first space 211 and a second space 212 by the speaker 22. A voice reflecting layer 214 (e.g., ceramic layer, metal layer or voice-absorbing material) is formed on the inner walls of the second space 212 of each voice box 21. The speaker 22 is electrically connected to the multimedia player 20.

In this embodiment, two voice blocking controllers 202 can be disposed on the multimedia player 20. The two voice blocking controller 202 are electrically connected the two speakers 22 to control the on/off function of sound output of the speakers 22, respectively. Moreover, the voice blocking controllers 202 can be disposed at appropriated positions on the voice boxes 21 to control the on/off function of sound output of the speakers 22, respectively.

A protruding portion 213 extends outwardly from the other side of each voice box 21. The diameter of the protruding portion 213 is the same as that of the speaker 22. The voice-transmitted tubes 23 connect to the protruding portions 213 and extend outwardly and bend. The diameter of the voice-transmitted tube 23 gradually decreases when extending outwardly. The voice-transmitted tubes 23 movably connect in the protruding portions 213 to allow the voice-transmitted tubes 23 to have the functions of adjusting length and angle.

The multimedia player 20 is further connected to a voice splitter 204. The voice splitter 204 can be disposed in the multimedia player 20. The voice splitter 204 is electrically connected to the speakers 22 to control the sound effect of the speakers 22.

The voice-transmitted tube 23 is hollow. An outlet 230 is disposed at the front end of each voice-transmitted tube 23. Each outlet 230 is designed to be of arc-shaped. Another voice reflecting layer 231 (e.g., ceramic layer, metal layer or sound absorbing material) is formed on the inner wall of each voice-transmitted tube 23.

A transmission wire (not shown) is connected between the multimedia player 20 and the voice box 21. The transmission wire is used to achieve electric connection between the multimedia player 20 and the speaker 22 so that the multimedia player 20 and the voice box 21 can be separated. It is not necessary to pivotally join the multimedia player 20 and the voice box 21.

As shown in FIG. 7, the multimedia player 20 can be arranged on a hat 3. A connecting member 31 (e.g., separable connecting member such as magnet or Velcro) is disposed on a front edge portion 30 of the hat 3. Another connecting member 205 is arranged on the multimedia player 20. The connecting member 205 of the multimedia player 20 can be joined with the connecting member 31 of the hat 3. Besides, a shock-voice buffer pad 206 can be disposed on the multimedia player 20. When the user wears the hat 3, the voice-transmitted tubes 23 can correspond to the front edges of the user's ears to achieve a surround effect. (Or the multimedia player 20 can be placed at an arbitrary position of the hat 3, and the transmission wire is used to let the voice-transmitted tubes 23 correspond to the user's ears for directly emitting music.)

When the multimedia player 20 plays the music, voice is played out via the speaker 22. The speaker 22 can generate a resonance in the first space 211 of the voice box 21 and a surround effect in the second space 212 by using the voice reflecting layer 214 in the voice box 21. The voice-transmitted tube 23 concentrates and guides the voice to the outlet 230 to directly emit the voice toward the user's ears. The voice reflecting layer 231 in the voice-transmitted tube 23 can be used to avoid scattering of voice and bad sound effect so that the user can fully enjoy the sound effects. Moreover, the design of the voice-transmitted tube 23 won't much affect the nearby environment. The shock-voice buffer pad 206 can be used to avoid the vibration of the speaker 22 that could affect the wearing comfort of the user.

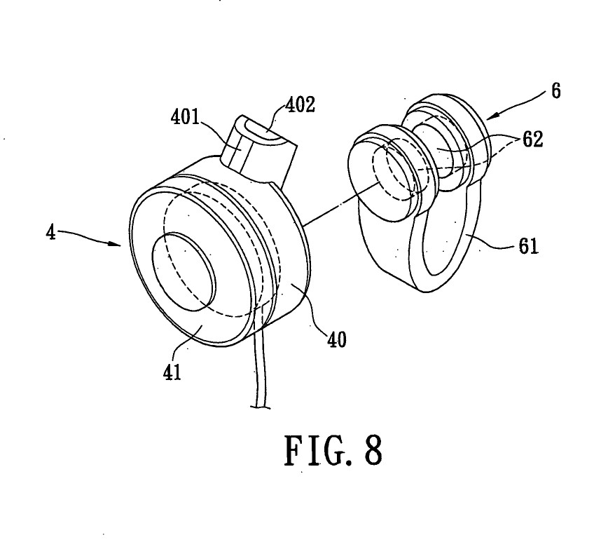

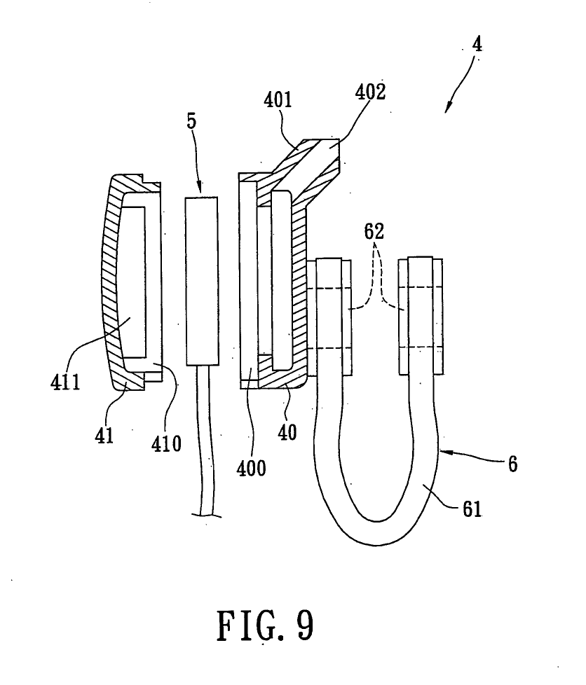

FIGS. 8 to 10 show a personal voice-transmitted device according to a second embodiment of the present invention. As shown in FIGS. 8 to 10, the personal voice-transmitted device comprises a main body 4, a speaker 5 and a locking structure 6 disposed at the outer side of a first shell 40.

The main body 4 includes a first shell 40 and a second shell 41 collocated with the first shell 40. The first shell 40 and the second shell 41 are assembled together in a locking manner (or the first shell 40 and the second shell 41 can be integrally formed together). The first shell 40 has a first space 400 and a voice-transmitted tube 401 extending outwardly from the first shell 40. The second shell 41 has a second space 410. The speaker 5 is disposed between the first shell 40 and the second shell 41 and near the first space 400.

The speaker 5 generates and retains a resonance tone by a resonance of the first space 400, and the resonance tone is transmitted to the outlet 402 of the voice-transmitted tube 401 via the voice-transmitted tube 401.

The user can enjoy excellent sound effects by using the first space 400 and the speaker 5 without affecting his hearing.

Besides, the second shell 41 has a resonance box 411 received in the second space 410. In addition to the resonance tone generated by the speaker 5 by a resonance of the first space 400, the user can also enjoy a resonance tone by the resonance of the speaker 5 and the resonance box 411.

The locking structure 6 is composed of a silicone member 61 and a magnet 62 disposed on the silicone member 61. Through the elasticity of the silicone member 61 of the locking structure 6, the main body 4 is elastically hung on the user's ear and is fixed on the user's ear by using the magnet 62.

In addition to locking on the user's ear, the magnet 62 can also stimulate acupuncture points on the ear to enhance the user's health. The voice-transmitted tube 401 can extend in a specific manner to let its outlet 402 face the user's ear. The speaker 5 can thus retain and generate a resonance tone by a resonance of the first space 400, and the resonance tone can be transmitted to the user's ear canal via the outlet 402 of the voice-transmitted tube 401. It is not necessary to plug the main body 4 into the ear to directly contact the ear so as to cause discomfort and a shutting feeling. The outlet 402 can be of an arc shape, a square shape or a circular shape to provide diversified selections for the user.

The locking structure 6 can also be composed of a leather member and a magnet disposed on the leather member. Through the toughness of the leather member, the user can stably adjust the hanging manner and arbitrarily change different styles according to one's liking.

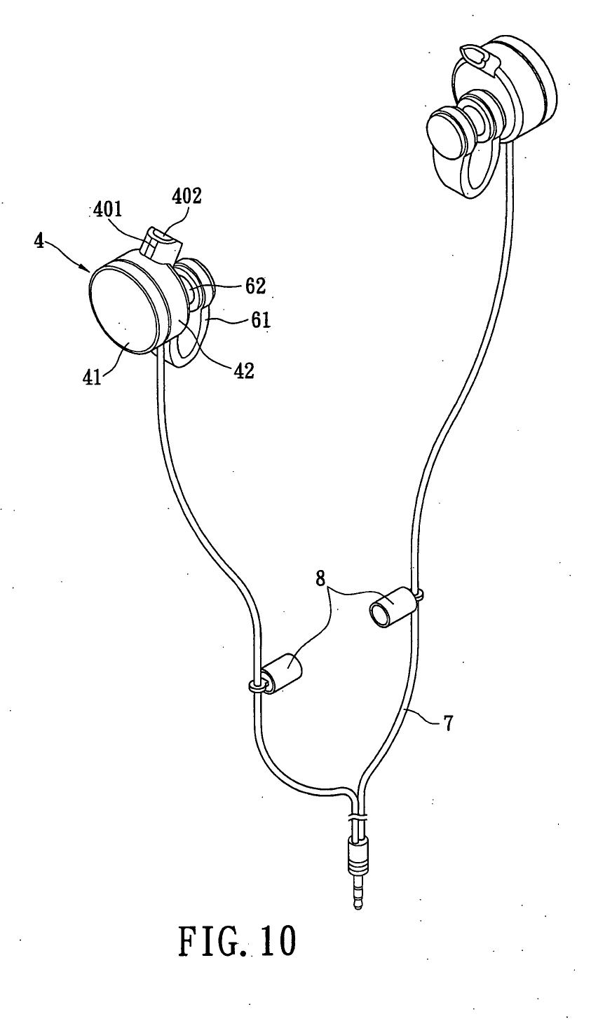

As shown in FIG. 10, in the second embodiment, the personal voice-transmitted device further comprises an earphone wire 7 electrically connected to the speaker 5 and a magnet button 8 disposed on the earphone wire 7. Through magnetic adhesion of the magnet button 8 (the earphone wire 7 forms a ring-shaped coil by using the adhesion of the magnet button 8), the user can hang the earphone wire 7 on his body (e.g., his neck). When the user does not wear the main body 4, the main body 4 can be temporarily unloaded on the shoulder without directly falling on the ground. When he wants to use the personal voice-transmitted device, he can conveniently and quickly wear the main body on his body. Besides, the earphone wire 7 can be hung on the user's body by using the magnet button 8.

When the earphone wire 7 is carelessly pulled by an external force, the magnet button 8 will also be pulled by the external force to let the earphone wire 7 automatically separate. Therefore, the user won't be pulled by the earphone wire 7 hung on his body to cause any hazard.

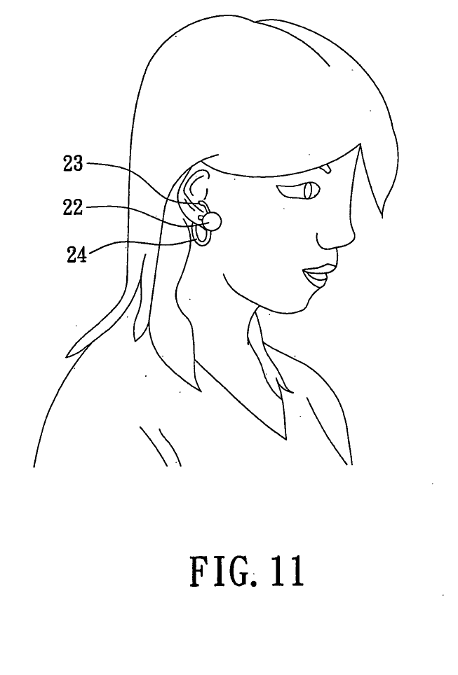

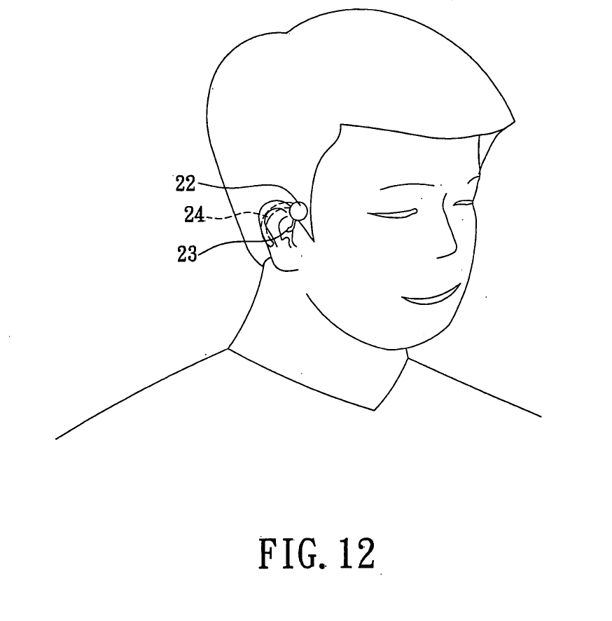

FIGS. 11 to 14 show a personal voice-transmitted device according to a third embodiment of the present invention. As shown in FIGS. 11 and 12, when the connection member 24 is an ear clip or an ear hanger, the speaker 22 can be fastened at the upper portion (ear pinna) or the lower portion (earlobe) of the user's ear so that the user can conveniently wear the device on his ears. The voice-transmitted tube 23 corresponds to the external ear canals of the user's ears. The speaker 22 can emit an excellent tone via the voice-transmitted tube 23 without directly contacting the user's ear canals.

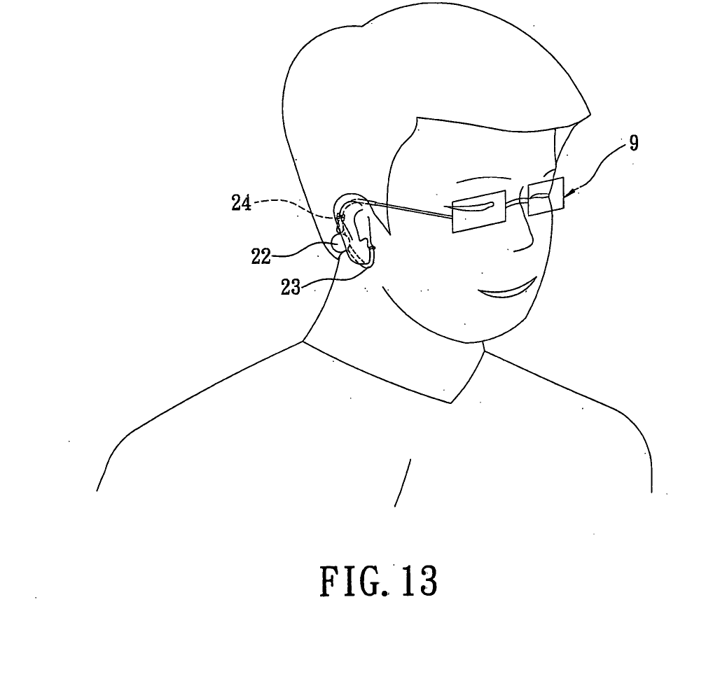

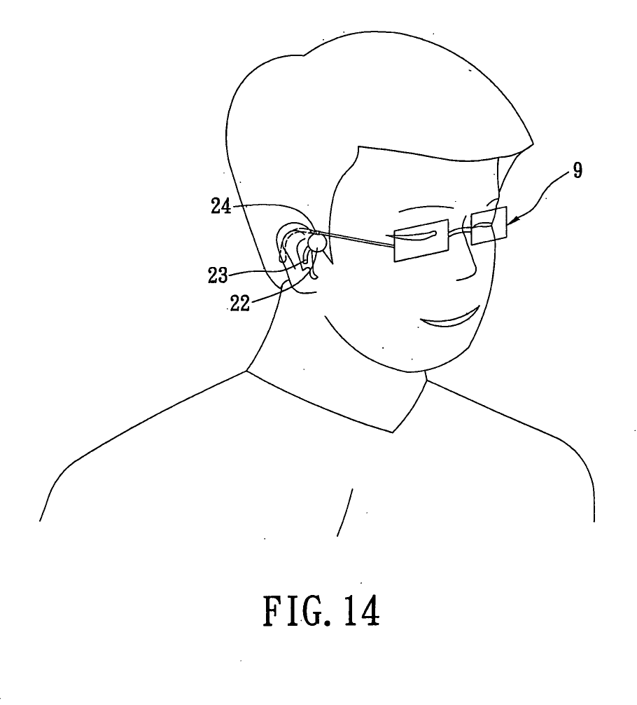

As shown in FIGS. 13 and 14, when the connection member 24 is an anti-slip hook or a collar, the user can sleeve the connection member 24 at an appropriate position of a glasses frame 9. The voice-transmitted tube 23 corresponds to the external ear canals of the user's ears. Similarly, the speaker 22 can emit an excellent tone via the voice-transmitted tube 23 without directly contacting the ear canals of the user's ears. Therefore, the user needs not to wear the earphone in his ears, hence avoiding uncomfortable feeling.

To sum up, in the present invention, the speaker 22 is arranged in the voice box 21 to divide the voice box 21 into the first space 211 and the second space 212. Moreover, the voice reflecting layer 214 is formed on the inner wall of the second space 212 to let the speaker 22 achieve a resonance tone effect and a concentration and surround effect, thereby improving the insufficiency of low-pitched tone of the prior art earphones. The voice-transmitted tube 23 can also be used to concentrate the tone and guide its direction so as to avoid scattering of tone and bad tone. Or the speaker 22 can be arranged in the voice-transmitted tube 23 to provide similar effects. Furthermore, voice is concentratedly emitted to surround the user's ears so that the user can fully enjoy the tone without much affecting the nearby environment. Even though the voice-transmitted tubes 23 are exposed, there is no influence. Besides, because the voice-transmitted tubes 23 do not directly contact the user's ears, the drawbacks in the prior art such as poor tone because of using an earphone, a shutting stress and an uncomfortable feeling because of inserting an earphone, an unsafe feeling because of hanging an earphone and a sanitation problem because of contacting an earphone can be solved. Moreover, the device can be used with no restriction on occasions and time.

Furthermore, in the present invention, the speaker 22 can be arranged in the voice box 21 to provide high-pitched tone, middle-pitched tone or low-pitched tone. By using different voice boxes 21 to individually output music via their corresponding voice-transmitted tubes 23, the device can apply to 5.1 or 7.1 sound channel earphones. For the time being, these earphones have the problem that surround sound effects are hard to simulate (because the speaker is in the earflap of the earphone), the voice-transmitted tube 23 can be used to guide voice into the earflap of the earphone to simulate the earflap as the living-room space.

The present invention can be designed to be an open player. For instance, the device can be joined with a hat 3 to show head-mounted acoustics effect. The music output is emitted to the ears with a large area to achieve sound effects as acoustics. The user can safely enjoy music when doing leisure activities in an open space.

Additionally, the present invention can achieve a personal playback design. For instance, the device can be joined with a connection member 24 such as an ear clip or an ear hanger, and the voice-transmitted tube 23 extends to the external ear canal of the user to emit voice toward the user's ears. The sound volume and tone are like those of prior art earphones, but the first space of the speaker 22 replaces the role of the user's ears (ear cavity) in the prior art earphones for resonance. The obtained low-pitched tone is excellent. Moreover, the user can wear the device for a long time. When there is an incoming call, the user can answer the call by using a Bluetooth module and a microphone without taking off the device. That is, the device can become part of the user's clothing.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A personal voice-transmitted device comprising:
at least one voice box having a speaker arranged therein, said voice box being divided to a first space and a second space by said speaker; and
at least one voice-transmitted tube connecting to one side of said voice box and having an outlet.

2. The personal voice-transmitted device as claimed in claim 1, wherein said voice box further connects a connection member.

3. The personal voice-transmitted device as claimed in claim 2, wherein said connection member is an ear clip, an ear hanger, an anti-slip hook or a collar.

4. The personal voice-transmitted device as claimed in claim 1 further comprising a multimedia player, wherein said multimedia player is electrically connected to said speaker via said voice box.

5. The personal voice-transmitted device as claimed in claim 4, wherein said multimedia player has more than one voice blocking controllers, which are electrically connected to said speaker.

6. The personal voice-transmitted device as claimed in claim 1, wherein voice reflecting layers are formed on inner walls of said second space of said voice box and said voice-transmitted tube, respectively.

7. The personal voice-transmitted device as claimed in claim 6, wherein said voice reflecting layer is a ceramic layer or a metal layer.

8. The personal voice-transmitted device as claimed in claim 6, wherein said voice reflecting layer is formed by means of electroplating or coating.

9. The personal voice-transmitted device as claimed in claim 1, wherein said voice-transmitted device is arranged on a hat.

10. The personal voice-transmitted device as claimed in claim 4, wherein said voice box is movably and pivotally connected to said multimedia player.

11. The personal voice-transmitted device as claimed in claim 4, wherein said voice box and said multimedia player are connected with a transmission wire, and said transmission wire achieves electric connection between said multimedia player and said speaker.

12. The personal voice-transmitted device as claimed in claim 1, wherein said voice box further has a protruding portion, and said voice-transmitted tube is movably and pivotally connected in said protruding portion.

13. A personal voice-transmitted device comprising:
a main body including a first shell and a second shell collocated with said first shell, said first shell having a first space and a voice-transmitted tube extending outwardly from said first shell, said voice-transmitted tube having an outlet, said second shell having a second space;
a speaker arranged between said first shell and said second shell and near said first space; and
a locking structure disposed at an outer side of said first shell so that said voice-transmitted tube can be arranged on an ear of a user;
whereby said speaker forms a resonance tone in said first space, and said resonance tone is transmitted to said outlet of said voice-transmitted tube via said voice-transmitted tube.

14. The personal voice-transmitted device as claimed in claim 13 further comprising an earphone wire electrically connected to said speaker and a magnet button arranged on said earphone wire.

15. The personal voice-transmitted device as claimed in claim 13, wherein said locking structure is composed of a leather member and a magnet disposed on said leather member, or a silicone member and a magnet disposed on said silicone member.
